(19) United States
(12) Patent Application Publication
(10) Pub. No.: US 2014/0014046 A1
(43) Pub. Date: Jan. 16, 2014

(54) Canine saliva absorber

(71) Applicant: Paul T. Foradori, Brecksville, OH (US)

(72) Inventor: Paul T. Foradori, Brecksville, OH (US)

(21) Appl. No.: 13/507,625

(22) Filed: Jul. 16, 2012

(51) Int. Cl. A01K 13/00

(52) U.S. Cl. 119/850

(57) ABSTRACT

Apparatus for collecting and absorbing saliva and/or drool from a dog preventing the saliva and/or drool from dropping onto the floor is disclosed. The apparatus is comprised of an elongated section of absorbent material having fastening means adjacent the oppositely disposed ends thereof. The elongated section of absorbent material is placed under the jaw of the dog and the fastening means adjacent the muzzle of the dog is wrapped around the muzzle of the dog and the oppositely disposed fastening means is wrapped around the back of the head of the dog securing the apparatus under the jaw of the dog permitting the collection and absorption of saliva and/or drool from the mouth of the dog.

### TECHNICAL FIELD

The present invention relates, in general, to apparatus for absorbing saliva from a domestic animal and, more particularly, for apparatus for collecting and absorbing saliva and/or drool from a dog.

### BACKGROUND ART

Dogs have a tendency to allow saliva and/or drool to drip from their mouths causing same to collect on the floor creating a very messy condition. This is particularly true when a dog is eating or drinking resulting in the surrounding area to become very messy and potentially hazardous due to the saliva and/or drool which drops from the dog's mouth. At the present time, there is no apparatus or device presently available to collect and/or absorb such saliva and/or drool preventing same from dropping onto the floor.

In view of the foregoing, it has become desirable to develop an apparatus for collecting and absorbing saliva and/or drool from a dog and which can be easily attached to and removed from the muzzle and surrounding area on the dog.

### SUMMARY OF THE INVENTION

The present invention solves the problem associated with the prior art and other problems by providing apparatus for collecting and absorbing saliva and/or drool from a dog preventing same from dropping onto the floor creating a very messy and potentially hazardous condition. The apparatus is comprised of an elongated piece of absorbent material having transverse fastening means adjacent one end thereof and longitudinally extending fastening means attached to the opposite end thereof. The elongated piece of absorbent material is placed under the jaw of the dog and the transverse fastening means is wrapped over the muzzle of the dog in order to fasten one end of the elongated piece of absorbent material to the muzzle of the dog. The longitudinal extending fastening means is wrapped around the back of the head of the dog in order to securely attach the other end of the elongated piece of absorbent material under the jaw of the dog. The piece of absorbent material is flexible and the transverse fastening means is expandable permitting the dog to eat and drink without removing same. The elongated piece of absorbent material collects and absorbs saliva and/or drool from the dog preventing same from dropping onto the floor creating a messy and potentially hazardous condition.

### BRIEF DESCRIPTION OF THE DRAWINGS

FIG. 1 is a perspective view of the canine saliva absorbing apparatus of the present invention and shows the placement of same on a dog.

FIG. 2 is perspective view of the canine saliva absorbing apparatus of the present invention shown by itself.

FIG. 3 is a top plan view illustrating the interior of the canine absorbing apparatus of the present invention.

FIG. 4 is a bottom plan view illustrating the exterior of the canine absorbing apparatus of the present invention.

FIG. 5 is a bottom view of the canine absorbing apparatus of the present invention.

FIG. 6 is a side elevation view of the canine absorbing apparatus of the present invention.

FIG. 7 is a front view illustrating a version of the fastening means which can be utilized by the canine absorbing apparatus of the present invention.

### DESCRIPTION OF THE PREFERRED EMBODIMENT

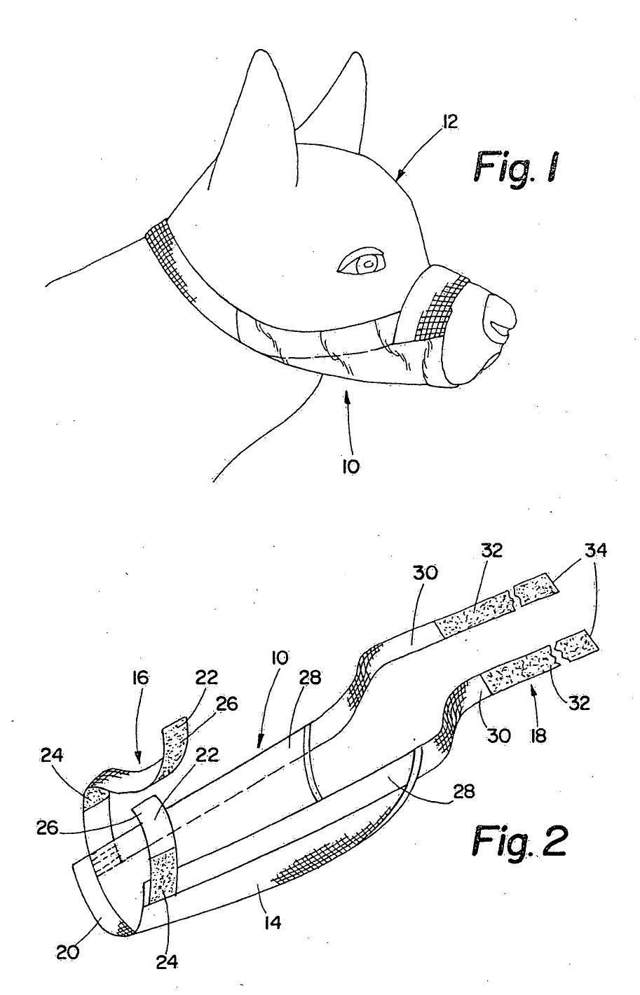

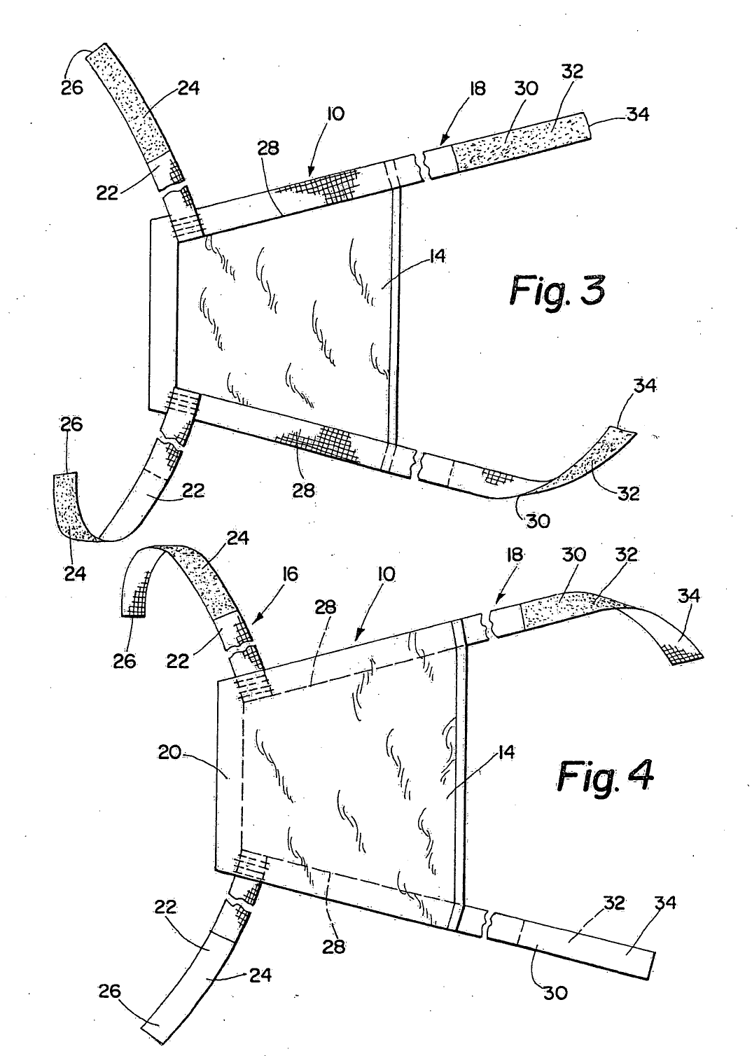

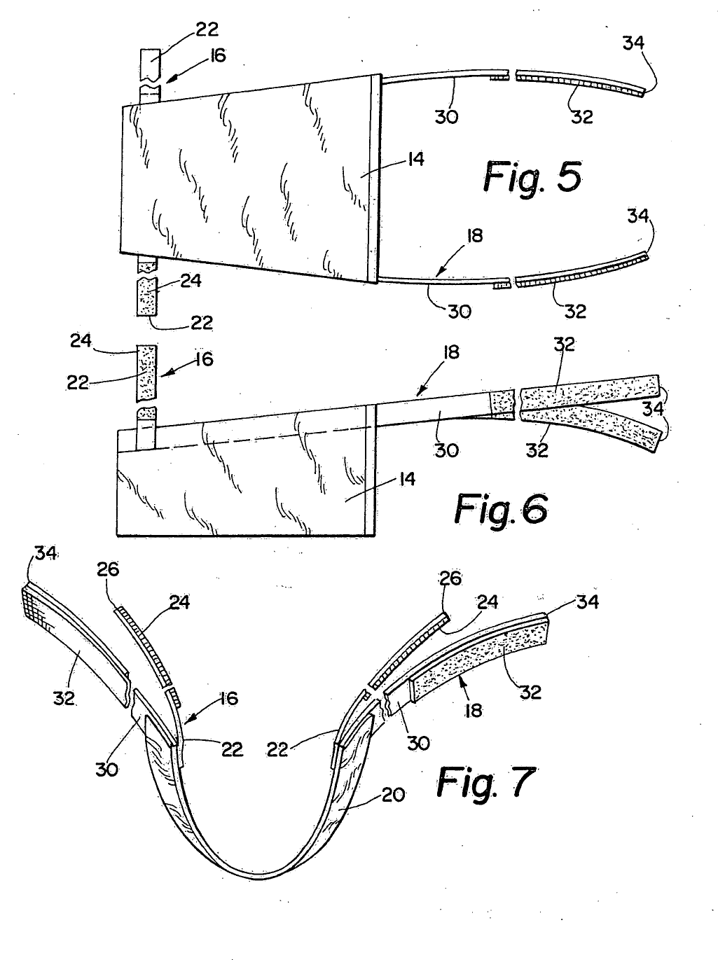

Referring now to the drawings where the Figures are for the purpose of describing the preferred embodiment of the present invention and are not intended to limit the invention described herein, FIG. 1 is a perspective view of the canine saliva absorbing apparatus 10 of the present invention and shows the placement of same under the jaw of a dog 12. Referring now to FIG. 2, the apparatus 10 is comprised of a longitudinally extending section 14 of absorbent material and oppositely disposed fastening means, shown generally by the numerals 16 and 18. The fastening means 16 is attached to the longitudinally extending section 14 of absorbent material adjacent end 20 thereof and is comprised of oppositely disposed straps 22 having fastening devices 24 attached adjacent the outer ends 26 thereof permitting the adjustable fastening together of same. The fastening means 18 is attached adjacent the oppositely disposed longitudinally extending outer edges 28 of longitudinally extending section 14 of absorbent material and is comprised of oppositely disposed straps 30 having fastening devices 32 attached adjacent the outer ends 34 thereof permitting the adjustable fastening together of same. The fastening means utilized can be of any one of a number of fastening means, such as buckles, hook-and-eye type fasteners, etc. In this instance, hook-and-eye type fasteners are shown merely for illustration purposes, but any type of fastening means can be utilized. In addition, oppositely disposed straps 22, 30 are shown for illustration purposes, however, a single strap can be substituted for either or both of the oppositely disposed straps 22, 30, and the resulting single strap would be wrapped around the muzzle and/or back of the head of the dog and attached to mating fastening means selectively placed on the section 14 of absorbent material. The section 14 of absorbent material is flexible and the straps 22 are expandable permitting the dog to readily eat and drink while wearing the apparatus 10.

In order to attach the apparatus 10 to the dog 12, the inner surface of the section 14 of absorbent material is placed under the jaw of the dog 12 and the oppositely disposed straps 22 comprising the fastening means 16 are wrapped around the muzzle of the dog 12 and adjustably joined together by the hook-and-eye fastening devices 24 attached thereto. The oppositely disposed longitudinally extending straps 30 are then wrapped around the back of the head of the dog and adjustable joined together by the hook-and-eye type fastening devices 32 attached thereto thus securing the apparatus 10 to the underside of the jaw of the dog 12.

Certain modifications and improvements will occur to those skilled in the art upon reading the foregoing. It is understood that all such modifications and improvements have been deleted herein for the sake of conciseness and readability but are properly within the scope of the following claims.

I claim:

1) Apparatus for collecting and absorbing saliva arid/or drool from a domestic animal comprising an elongated section of material for placement adjacent the underside of the jaw of said animal, said material section having a first end and an oppositely disposed second end, first fastening means attached adjacent to said first end of said material section, and second fastening means attached to said second end of said material section, said first fastening means being wrappable around the muzzle of said animal attaching said first end of said material section under the jaw of said animal, said second fastening means being wrappable around the back of the head of said animal attaching said second end of said material section under the jaw of said animal and securing said apparatus to the underside of the jaw of said animal permitting the collection and absorption of saliva and/or drool from the mouth of said animal.

2) The apparatus as defined in claim 1 wherein said first fastening means comprises at least one strap attached adjacent said first end of said section of material and positioned in a substantially transverse relationship to the longitudinal axis of said elongated section of material.

3) The apparatus as defined in claim 2 wherein said at least one strap has a fastening device attached adjacent the outer end thereof.

4) The apparatus as defined in claim 1 wherein said elongated section of material has oppositely disposed longitudinal extending edges, and said second fastening means comprises at least one strap attached to one of said oppositely disposed longitudinally extending edges of said section of material.

5) The apparatus as defined in claim 5 wherein said at least one strap has a fastening device attached adjacent the outer end thereof.

6) The apparatus as defined in claim 1 wherein said elongated section of material is formed from an absorbent material.

7) The apparatus as defined in claim 1 wherein said first fastening means is formed from an expandable material.
